(19) United States
(12) Patent Application Publication
(10) Pub. No.: US 2007/0074185 A1
(43) Pub. Date: Mar. 29, 2007

(54) Identifier expressions

(75) Inventors: Henricus Johannes Maria Meijer, Mercer Island, WA (US); Peter F. Drayton, Redmond, WA (US); Brian C. Beckman, Newcastle, WA (US); Paul A. Vick, Seattle, WA (US); Amanda Silver, Seattle, WA (US); David N. Schach, Redmond, WA (US); Avner Y. Aharoni, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/215,135

(22) Filed: Aug. 30, 2005

(51) Int. Cl. G06F 9/45

(52) U.S. Cl. 717/140; 717/162

(57) ABSTRACT

Systems and methods that enhance a programming language with late binding via employing expressions of the form “Expression” in syntactic positions—wherein previously only compile-time constants were allowed. In a related aspect, the subject innovation can parameterize over a member name, via examining the grammar of the language (and all the available helpers) and replace identifiers or constants with an expression(s).

This application is related to U.S. patent application Ser. No. ______, filed on Aug. 30, 2005, entitled RELAXED AND EXTENDED DELEGATES [Ref: MS314162.01/MSFTP1119US)]. The entirety of this application is incorporated herein by reference.

### BACKGROUND

As programming approaches and foundations have evolved, application programming interfaces (APIs) and programming schemas have been developed to standardize and unify programming methodologies that were previously multi-variant and relatively incompatible. Modern programming therefore often involves employing APIs and schemas in conjunction with reusable libraries. Such Programming languages continue to evolve to facilitate specification by programmers as well as efficient execution.

Compilers and/or interpreters bear the burden of translating high-level logic into executable machine code. In general, a compilers and/or interpreters are components that receive a program specified in a source programming language (e.g., C, C#, Visual Basic, Java . . . ) and covert the logic provided thereby to machine language that is executable by a hardware device. However, the conversion need not be done verbatim. In fact, conventional compilers and/or interpreters analyze the source code and generate very efficient code. For example, programmers write code that sets forth a logical flow of operations that is intuitive and easy for humans to understand, but is often inefficient for a computer to execute. Compilers and/or interpreters can identify inefficiencies and improve program performance at the hardware level by eliminating unnecessary operations and/or rearranging the execution of instructions while still achieving the intended results. In this manner, programmers can create robust and efficient software.

Programming languages include static languages and dynamic languages. A static language requires most program structure—such as the types of variables and function arguments—to be determined at compile time. The compiler can detect errors and optimize performance at the cost of run-time flexibility. On the other hand, dynamic languages allow a user to make more run-time changes to program structure, such as passing arguments of different types to the same function and, in some languages, defining new types or classes. A dynamic environment can enable run-time definition and linking.

Moreover, an important feature of a dynamic language is “late-binding”, the ability to access members on an object without knowing the static type of the receiver object (nor of the arguments), or to apply (arithmetic) operators without knowing the static types of the operands. The actual member access/(arithmetic) operation is chosen at runtime based on the dynamic type of the receiver/arguments.

The Visual Basic language allows late binding over values of static type Object. In the following example, the member access expression P.Age is late-bound since the static or compile-time type of the receiver P is Object. Similarly, the addition N+1 is late-bound since the static type of the first operand N is Object. Finally, the update P.Age=M is late-bound, since the static type of the receiver P is also Object:

| | |
|---|---|
| Class Person | |
| Sub New(Age As Integer, ...) | |
| Me.Age = Age | |
| ... | |
| End Sub | |
| Dim Age As Integer | |
| Sub GrowOlder(Amount As Integer) | |
| Me.Age = Me.Age + Amount | |
| End Sub | |
| End Class | |
| Dim P As Object = New Person(42,...) | REM P has static type Object, dynamic type |
| Person | |
| Dim N As Object = P.Age | REM late-bound field access, N = 42 |
| Dim M As Object = N+1 | REM late-bound arithmetic operation, M = 43 |
| P.Age = M | REM late-bound field update, P.Age = 43 |

Similar forms of late binding exist in languages such as Python, Ruby, Groovy, JavaScript, and the like. However, the actual member that is accessed, in this case Age, is still fully determined at compile-time, e.g., it is early-bound.

The ability to late-bound over member names is especially important in data-intensive programs where the structure of the data is not known statically, and for writing generic interpretative code. Yet, in programming there typically exists a restriction that identifiers (and in other scenarios type names) have to be compile-time constants. Such can hinder flexibility of the programming languages.

Therefore, there is a need to overcome the aforementioned exemplary deficiencies associated with conventional systems and devices.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation provides for systems and methods that enhance a programming language with late binding (e.g., Visual Basic), via employing expressions of the form “Expression” in syntactic positions—wherein previously only compile-time constants were allowed. For example, the subject innovation can augment IdentifierOrKeyword to include Expression, wherein the type Expression can be convertible to string;

MemberAccessExpression ::=[[MemberAccessBase].]
IdentifierOrKeyword [(Of TypeArgumentList)]
IdentifierOrkeyword ::= Identifier | Keyword | (Expression)

Dim P As Object = ... as above...
Dim S As String = “A”
Dim N As Object = P.(S & “ge”) REM Member name as expression
P.(Console.ReadLine()) = N+1

In a related methodology, the subject innovation can parameterize over a member name, via examining the grammar of the language (and all the available helpers) and replace identifiers or constants with an expression. For example, in the grammar of the programming language there can exist member access expressions in form of E.M (E represents an expression and M an identifier). Accordingly, the subject innovation enables an expression instead of the identifier key word associated with the member access expression. Moreover, a helper associated with a compiler can provide a method name as a string, which is leveraged to place an expression therein. Thus, a commitment to a method at compile time can be mitigated, and fragments of a program can be dynamic and in form of an arbitrary expression.

According to a further aspect, an expression can replace an identifier in “named arguments”. Typically, a named argument is an argument with a name that is predefined in the object library, and the named arguments can be employed to assign values in any order, instead of providing a value for each argument in a specified order expected by the syntax. For named arguments there are identifier key words that can be replaced with an expression. More over, the helper also employs the name in the string, which designates an identifier that is replaceable by an expression in accordance with an aspect of the subject innovation. Such also results in an argument name that is dynamic.

In yet a further aspect, in context of spliced arguments the subject innovation can compute the arguments as a list or block, wherein an expression can deliver all related values. Such expression can compute a slice of argument list, wherein constant(s) are replaced with dynamic content.

Moreover in context of a delegate, the subject innovation can capture a method and pass it for later call in event handlers. As such, a method on a class can be captured and passed around, and a delegate dynamically created based on name of the method passed. Thus, an identifier that is located at a syntactic position can be dynamically computed, and also a static representation of a list can be replaced with a dynamic representation thereof (e.g., an argument list). Moreover, a type name or a constructed type name (e.g., qualified identifier) can be replaced by an expression, and a choice of object created dynamically at run time. In a related aspect, SimpleTypeName and ConstructedTypeName can include yet again an expression of the form (Expression).

It is to be appreciated that the subject innovation can be implemented in any combination of the scenarios described above, e.g., both for named delegates and arguments and the like, alone or in combination with other aspects described herein. Moreover, it is to be appreciated that helpers can be supplied for interacting with method names, argument names, type names, string or system type value, argument splicing and the like, which can be leveraged to place expression therein.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a programming environment that is enhanced via employing variable in syntactic positions wherein previously only compile-time constants were allowed.

FIG. 2 illustrates a block diagram wherein the subject innovation can parameterize over a member name, via examining the grammar of the language to replace identifiers or constants with an expression.

FIG. 3 illustrates a block diagram for an expression that can replace an identifier in “named arguments”.

FIG. 4 illustrates a further aspect of the subject innovation in context of spliced arguments.

FIG. 5 illustrates an exemplary methodology in accordance with an aspect of the subject invention.

FIG. 6 illustrates an exemplary flow chart that replaces a constant with expressions in named arguments.

FIG. 7 illustrates an expression in accordance with an aspect of the subject innovation.

FIG. 8 illustrates a programming environment with a source program that supports expressions in syntactic positions, wherein previously only compile-time constants were permissible.

FIG. 9 is a block diagram depicting a compiler environment that can be utilized to implement replacement of constants with expressions.

FIG. 10 illustrates an exemplary environment for implementing various aspects of the subject innovation.

FIG. 11 is a schematic block diagram of an additional-computing environment that can be employed to implement the subject innovation.

### DETAILED DESCRIPTION

The various aspects of the subject invention are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term computer program as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD). . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

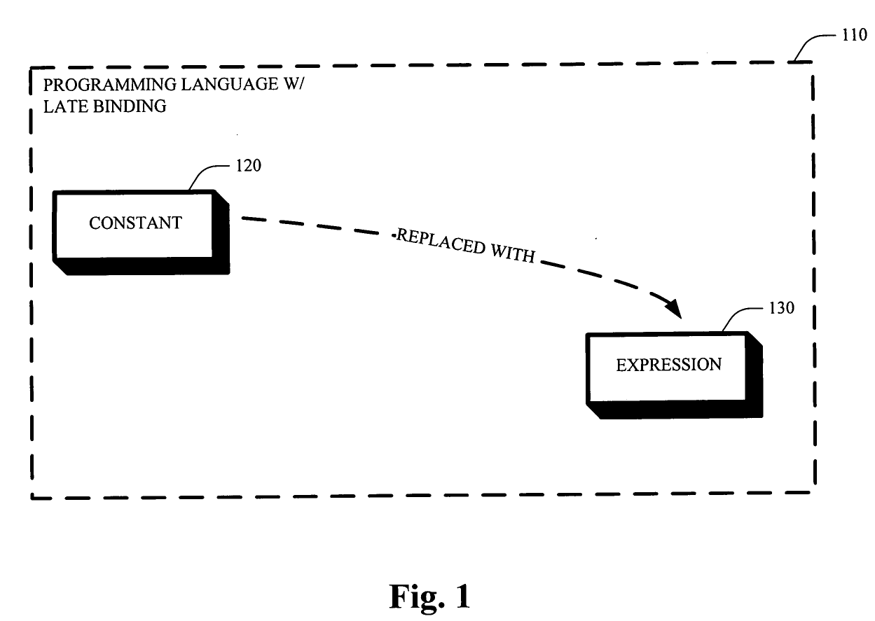

Turning initially to FIG. 1, a programming environment 100 is illustrated, and the programming language 110 (e.g., Visual Basic) of the subject invention is enhanced via employing variable in syntactic positions—wherein previously only compile-time constants were allowed. Such can provide a replacement for a constant 120 (e.g., type name or a constructed type name) by an expression 130, and a choice of object created dynamically at run time

The ability to late-bound over member names is especially important in data-intensive programs where the structure of the data is not known statically and to write generic interpretative code. In general binding refers to the way in which a programming code such as Visual Basic code accesses objects in another application. For example, when a user employs Automation from one application to work with objects in another application, the application in which the Visual Basic code is written is the Automation controller. Likewise, the application whose objects the user are working with is the Automation server. When an Automation controller creates an object variable that points to an object supplied by an Automation server, Visual Basic must typically verify that the object exists and that any properties or methods used with the object are specified correctly—(It is to be appreciated that the subject innovation is not so limited, and can be implemented in other systems such as run-time reflections, VB.Net, and the like.) Such verification process is known as binding. There exist two types of binding with which Visual Basic employs, namely early binding and late binding.

Early binding is typically the solution to the problem of slow Automation performance. Early binding occurs at compile time rather than run time, so if the code is saved in a compiled state, binding is complete before the code is even run. When employing early binding, Visual Basic typically need not continually verify the object information while using the object during the execution of the application.

Not all Automation servers support early binding. The Automation server must in general provide a type library, containing information about the server's objects, methods, and properties. To take advantage of early binding, a user must typically set a reference to the Automation server's type library. Visual Basic loads the type library into memory, which enables it to recognize these objects and bind them when the code is compiled.

Consider the example of:

Class Person
Age As Integer
Sub Grow Older (Amount As Integer)
end Class
Dim P As Person
P.Grow Older (5)

For early binding, the compiler knows that P has type person, and statically checks the type passed. Put differently, in traditional programming languages the compiler knows that P is type person and can look at the declaration and knows to call the type. Visual basic enables both early and late binding.

When the target of the expression can be deferred until run time, such deferring processing is referred to as late binding. Late binding allows Object variables to be used in a typeless way, where all resolution of members is based on the actual run-time type of the value in the variable. If strict semantics are specified by the compilation environment, late binding causes a compile-time error. Non-public members can be ignored when performing late binding, including for the purposes of overload resolution. Moreover, unlike the early-bound case, invoking or accessing a Shared member late bound will cause the invocation target to be evaluated at run time.

In the above example, in late binding Dim P As Object=New Person the compiler is not aware that P is a person, as the dynamic type is a person and the static type is an object. As such, the compiler only knows that P is an object (static type), and at run time it is a person (dynamic type). Accordingly, the compiler can call a helper and pass the string as well as all the arguments thereto, as Helper (P, “Grow Older”, 5). Thus, the member name is passed to helper for determination at run times and related method called. The subject innovation supplies an ability to abstract, wherein an arbitrary expression can be passed, and mitigates a requirement to commit at compile time the method to be called. For example, the following can be allowed:

P.(F( ))(5)
F( ) As string
If it Rains
Then Return Grow Older
Else Return Take Nap,

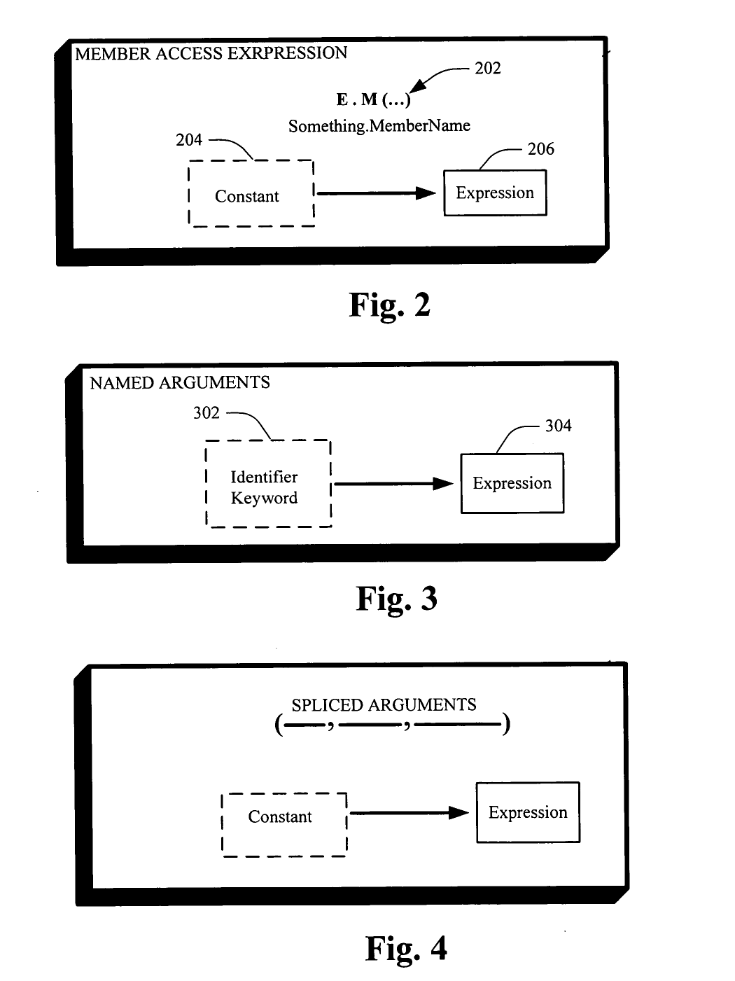

FIG. 2 illustrates a block diagram wherein the subject innovation can parameterize over a member name, via examining the grammar of the language (and all the available helpers) and replace identifiers or constants with an expression. For example, in the grammar of the programming language there can exist member access expressions in form of E.M (E represents an expression and M an identifier) or .M.

Typically, a member access expression is used to access a member of an entity. A member access of the form E.M, where E is an expression, a built-in type, or omitted and M is an identifier, is evaluated and classified. For example, If M identifies a shared variable or an instance variable, and if the variable is read-only, and the reference occurs outside a constructor of the class in which the variable is declared appropriate for the kind of variable (shared or instance), then the result is the value of the variable M in the object referenced by E. If a type (T) of a value or variable for E, is a reference type, then the result is the variable M in the object referenced by E. Yet, if T is a value type and the expression E is classified as a variable, the result is a variable; otherwise the result is a value. Moreover, if T is Object, then the result is a late-bound member lookup classified as a property group with an associated instance expression of E.

As such, the late binding can be generalized by allowing expressions of the form (Expression) in syntactic positions where previously only compile-time “constants” were allowed. For example, IdentifierOrKeyword can be augmented to include (Expression) where the type Expression should be convertible to String;

MemberAccessExpression ::=[[MemberAccessBase].]
IdentifierOrKeyword [ (Of TypeArgumentList) ]
IdentifierOrKeyword ::= Identifier | Keyword | (Expression)

This allows expressions such as P.(S) or .(S) indicated below, where the member name is determined dynamically as the result of evaluating the expression S & “ge”:

Dim P As Object = ... as above...
Dim S As String = “A”
Dim N As Object = P.(S & “ge”) REM Member name as expression
P.(Console.ReadLine( )) = N+1

Moreover, in general an expression that employs dynamic member names is always qualified as a late-bound expression. Alternatively, the use dynamic member names can be restricted to member-access expressions whose target (receiver) qualifies the expression as late-bound. In the former case, the following program is permissible:

| | |
|---|---|
| Dim P As Person = ... | REM statically |
| Dim N As Object = P.(“Age”) | REM Member name as expression |
| | REM expression now qualified as late- |
| | bound |

Allowing dynamic member names in an IdentifierOrKeyword position automatically allows named parameters (e.g., parameter name, fragment of a parameter list associated with a member invocation, and the like) in invocation and index expressions to be late-bound.

IndexExpression ::= Expression ( [ ArgumentList ] )
InvocationExpression ::= Expression [ ( [ ArgumentList ] ) ]
ArgumentList ::=PositionalArguments [, NamedArguments]
PositionalArguments ::= Expression, ..., Expression
NamedArguments ::= IdentifierOrKeyword := Expression, ...,
IdentifierOrkeyword := Expression

Dim P as Object = New Person(42)
P.GrowOlder( (“Amount”) := 5)

As explained earlier, an invocation or index expression that employs a dynamic member name expression is qualified as late-bound. Alternatively, the use dynamic member names can be restricted to index and invocation expressions whose target (receiver) expression already qualifies the expression as late-bound. Accordingly, the subject innovation can parameterize over a member name, via examining the grammar of the language (and all the available helpers) and replace identifiers or constants with an expression. Thus, a commitment to calling a method at compile time can be mitigated. For example, in context of intercepting method calls, a wrapper can be created that intercepts method calls via helpers, and create a log to generically call underlying functions.

FIG. 3 illustrates a block diagram for an expression that can replace an identifier in “named arguments” 300. Typically, a named argument is an argument with a name that is predefined in the object library, wherein named arguments can be employed to assign values in any order, instead of providing a value for each argument in a specified order expected by the syntax. For named arguments there are identifier key words 302 that can be replaced with an expression 304. Moreover, a helper can employ the name in the string, which designates an identifier that is replaceable by an expression in accordance with an aspect of the subject innovation. Such also results in an argument name that is dynamic.

Likewise, FIG. 4 illustrates a further aspect in context of spliced arguments 400, wherein the subject innovation can compute the arguments as a list or block, and an expression can deliver all related values. Such expression can compute a slice of argument list, wherein constant(s) are replaced with a dynamic component.

For example, the number of arguments in an argument list is an entity that can typically be statically determined. Accordingly, the invocation expression F(A, B, C, D) has four arguments. Often it is desired to compute fragment of the argument list and “splice” them in. Syntax of ArgumentList can be extended as follows:

ArgumentList ::= PositionalArguments [, NamedArguments]
PositionalArguments ::= PositionalArgumentExpression, ...,
PositionalArgumentExpression
PositionalArgumentExpression ::= Expression | { Expression }
NamedArguments ::= NamedArgumentExpression, ...,
NamedArgumentExpression
NamedArgumentExpression ::= IdentifierOrKeyword := Expression |
{Expression }

In the case of a PositionalArgumentExpression the result of the expression E in {E} must typically be of type IEnumerable. Moreover, in the case of a NamedArgumentExpression, the result of the expression E in {E} must typically be of type IEnumerable(Of NamedArgument) or of type IEnumerable where all elements in the resulting collection are convertible to NamedArgument. The type NamedArgument has members Name As String and Argument As Object and is the dynamic representation of a NamedArgumentExpression.

As explained earlier, an expression that employs a dynamic argument list {E} is qualified as late-bound. Alternatively, the use of dynamic argument lists can be restricted to expressions that are already qualified as late-bound. It is noted that the AddressOfExpression takes a MemberAccessExpression, and hence permits dynamic member names as well, and thus in general expressions are qualified as late-bound as:

AddressOfExpression ::= AddressOf MemberAccessExpression

For example, a user can write expressions such as AddressOf P.(“Age”) or AddressOf P.Age (where P has type Object). (In current Visual Basic, applying AddressOf to an expression that is qualified as late-bound is not allowed.) Assuming the declaration of a delegate type D as follows:

Delegate Function D(..., A As T, ...) As R

And further assuming that an AddressOfExpression E that is qualified as late-bound is used in the context of creating a delegate of type D, for example new D(AddressOf E). This expression is considered a shorthand for the early-bound delegate creation expression that assumes C# anonymous method-like syntax.

New D( Function (..., A As T, ...) E(..., A,...))

The implementation of late-bound member names and argument splicing is in general easily retrofitted on the already existing late-binding infrastructure since that usually represents member names as strings. Concretely, in the Visual Basic case, all late-bound helpers take the name of the member and the names of named arguments as strings. Instead of employing a string constant, the compiler for late-bound expressions now emits the expressions that evaluate at runtime to strings.

Besides identifiers, the subject innovation also permits late-bound types. For example, when performing a late-bound call on a generic method as in the following example

```
Class C
  Function F(Of T)(..., A As T, ...)
    End Function
End Class
Dim C As Object = new C()
C.F(Of (GetTypeFromHandle(...))) (..., X, ...)
```

Such can be obtained by extending the production for SimpleTypeName and ConstructedTypeName to include yet again an expression of the form (Expression) where in this case the type of the Expression must typically be of System.Type:

TypeName ::= ArrayTypeName | NonArrayTypeName
NonArrayTypeName ::= SimpleTypeName | ConstructedTypeName
SimpleTypeName ::= QualifiedIdentifier | BuiltInTypeName |
(Expression)
ConstructedTypeName ::= QualifiedIdentifier ( Of TypeArgumentList )
| (Expression) (Of TypeArgumentList)

Any expression that involves a dynamic type name is qualified as late-bound. In some cases (as indicated below for the Visual Basic grammar) the expressions in which a dynamic type name appears is typically not qualified as late-bound a priori.

As explained earlier, the implementation of such constructs can employ some late-binding infrastructure that takes dynamic values of type System.Type instead of static type references (in MSIL terms tokens). The advantages of this feature can be increased if an implicit conversion is assumed from String to System.Type by invoking the System.Type.GetType(String) static method.

```
ObjectCreationExpression ::= New NonArrayTypeName
[ ( [ ArgumentList ] ) ]
ArrayCreationExpression ::=
  New NonArrayTypeName ArraySizeInitializationModifier
  ArrayElementInitializer
DelegateCreationExpression ::= New NonArrayTypeName ( Expression )
CastExpression ::=
  DirectCast ( Expression , TypeNameOrExpression) |
  TryCast ( Expression , TypeNameOrExpression) |
  CType ( Expression , TypeNameOrExpression) |
  CastTarget ( Expression )
TypeNameOrExpression ::= TypeName | Expression
```

Moreover in context of a delegate, the subject innovation can capture a method and pass it for later call in event handlers. Typically in Visual Basic, delegates are objects employed to call methods of other objects. Such delegates can also be described as type-safe function pointers as they are similar to function pointers used in other programming languages. Unlike function pointers Visual Basic Net delegates can be called without a specific instance of a class—and instance methods. For example, delegates can be useful in situations where an intermediary is required between a calling procedure and the procedure being called. A delegate statement can be used to declare a delegate. As such, delegates can be considered as reference type that refers to a shared method of a type or to an instance method of an object. In general, the delegate statement defines the parameter types and return type of a delegate class. Moreover, any procedure with matching parameter types and return type may be used to create an instance of this delegate class. The procedure can then later be invoked via the delegate instance, by calling the delegate's Invoke method.

For example a delegate can be defined as:

Delegate Sub F (X As Integer) Such declares a delegate that takes an integer and returns nothing—similar to a subroutine

Dim Q As F
Address Of P. Grow Older

and subsequently it can be stated as Q(5). The delegate can capture the “Grow Older” method on the person, (which is passed around and being called) wherein a method on a class is being captured and passed around (e.g., event handlers.)

Also, the following can be supplied:

Dim W As Wine
Dim P As Person
Dim Q As F = Address of P. (“Grow older”)
Q As F = Address of W(“Grow Older”)

Accordingly, the delegate can be dynamically created based on what name is passed. The delegate can be taken in a late bound way where P can also be an object. As such, a method on a class can be captured and passed around, and a delegate dynamically created based on name of the method passed. Thus, an identifier that is located at a syntactic position can be dynamically computed, and also a static representation of a list can be replaced with a dynamic representation thereof (e.g., an argument list). Moreover, a type name or a constructed type name can be replaced by an expression, and a choice of object created dynamically at run time.

Considering the following generic function wherein the function is parameterized over a type

Class
Function F(Of T) (...A As t)
when the function is called
C.F (Of Int) (....., 5, .....)
(t=int )

wherein “t” is bound to integer and passed as “5”. As such a constant exists, and the compiler provides a manner to reify into run time values. Accordingly, instead of passing a compile time type, a reify type can be passed. Thus at runtime, a type to be instantiated can be computed—instead of being determined at compile time. By examining grammar of the language, constructed type names can be identified and replaced with expressions. Accordingly, C.F (of Get type ( . . . )) ( . . . 5) can be supplied as part of the programming language.

Moreover, in the context of C type for VB, which is a cast given to an expression and type, for example the following can be provided:

CType (5, Integer), wherein a string 5 can be cast into an integer. Accordingly, the type constant can be replaced by an expression to add flexibility.

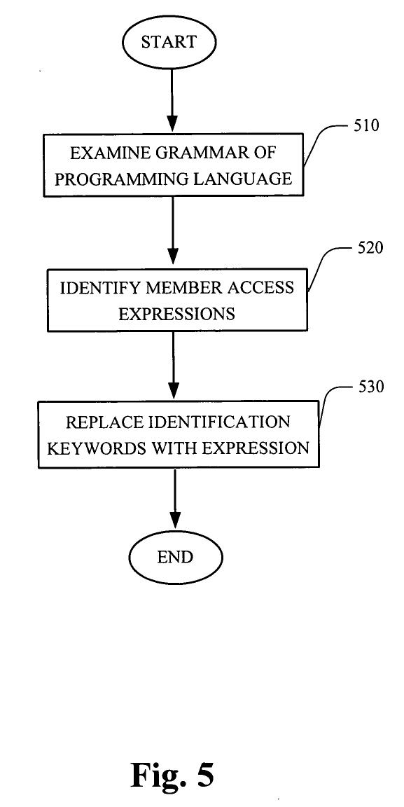

FIG. 5 illustrates an exemplary methodology 500 in accordance with an aspect of the subject invention. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially, and at 510 the grammar of the programming language is examined systematically to locate the identifiers or constants that can be replaced with an expression. For example at 520, member access expressions can be identified. Subsequently, and at 530 identification keywords can be replaced with expressions.

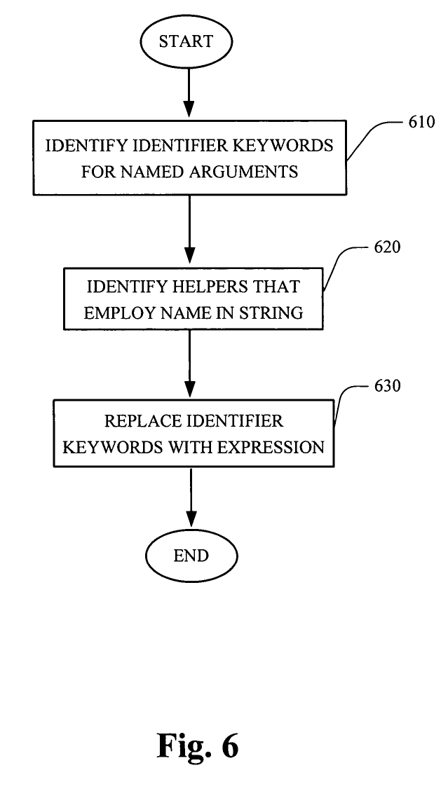

Likewise, FIG. 6 illustrates an exemplary flow chart 600 for replacing constant with expressions in named arguments. For named arguments there are identifier key words that can be identified at 610, and replaced with an expression. Moreover, helper(s) can also employ a name in the string, which designates an identifier that can be identified at 620, and replaced at 630 by an expression in accordance with an aspect of the subject innovation. Such can result in an argument name that is dynamic.

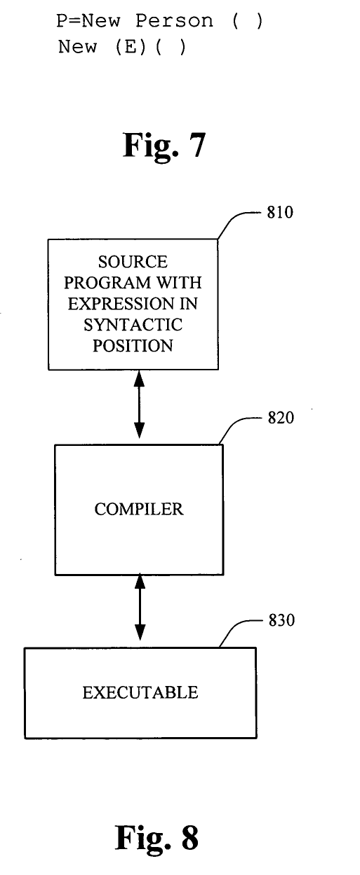

FIG. 7 illustrates an expression in accordance with an aspect of the subject innovation, wherein for a class person and a type name, an expression E can be introduced, to dynamically decide which object should be created. For example, such can be late bound, wherein systematically static entities are replaced with dynamic ones.

FIG. 8 illustrates a programming environment 800 with a source program 810 that supports expressions in syntactic positions, wherein previously only compile-time constants were allowed. Such can provide for a replacement of a type name or a constructed type name by an expression, and a choice of object created dynamically at run time. The system 800 includes a source program 810 that can be developed, designed, or edited by an Integrated Development Environment (IDE). The IDE can be associated with a more elaborate programming station such as a developer studio application for example, or associated with a more basic tool such as a code text editor, for example. A compiler 820 processes the source program according to well-known compilation techniques to produce executable code 830 for a computer.

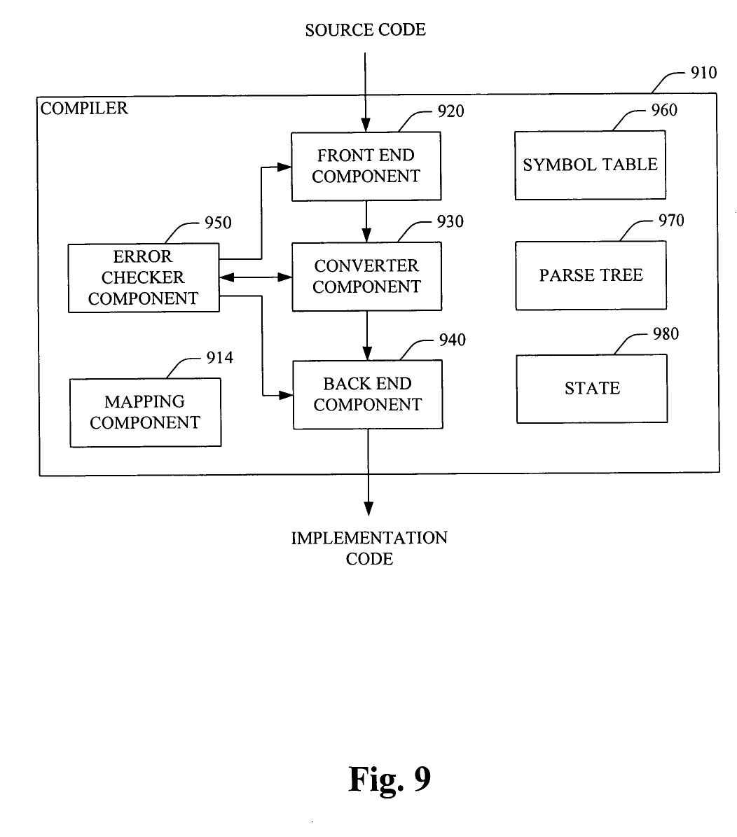

FIG. 9 is a block diagram depicting a compiler environment 900 that can be utilized to implement replacement of constants with expressions of the subject innovation. The compiler environment 900 includes a compiler 910 including a mapping component 914, a front-end component 920, a converter component 930, a back-end component 940, an error checker component 950, a symbol table 960, a parse tree 970, and state 980. The compiler 910 accepts source code as input and can produce implementation code as output. The input can include but is not limited to programmatic expressions as described herein. The relationships amongst the components and modules of the compiler environment illustrate the main flow of data. Other components and relationships are not illustrated for the sake of clarity and simplicity. Depending on implementation, components can be added, omitted, split into multiple modules, combined with other modules, and/or other configurations of modules.

The compiler 910 can accept as input a file having source code associated with processing of a sequence of elements. The source code may include various expressions and associated functions, methods and/or other programmatic constructs. The compiler 910 can process source code in conjunction with one or more components for analyzing constructs and generating or injecting code.

A front-end component 920 reads and performs lexical analysis upon the source code. In essence, the front-end component 920 reads and translates a sequence of characters (e.g., alphanumeric) in the source code into syntactic elements or tokens, indicating constants, identifiers, operator symbols, keywords, and punctuation among other things.

The converter component 930 parses the tokens into an intermediate representation. For instance, the converter component 930 can check syntax and group tokens into expressions or other syntactic structures, which in turn coalesce into statement trees. Conceptually, these trees form a parse tree 970. Furthermore and as appropriate, the converter module 930 can place entries into a symbol table 930 that lists symbol names and type information used in the source code along with related characteristics.

A state 980 can be employed to track the progress of the compiler 910 in processing the received or retrieved source code and forming the parse tree 970. For example, different state values indicate that the compiler 910 is at the start of a class definition or functions, has just declared a class member, or has completed an expression. As the compiler progresses, it continually updates the state 980. The compiler 910 may partially or fully expose the state 980 to an outside entity, which can then provide input to the compiler 910.

Based upon constructs or other signals in the source code (or if the opportunity is otherwise recognized), the converter component 930 or another component can inject code corresponding to facilitate efficient and proper execution. Rules coded into the converter component 930 or other component indicates what must be done to implement the desired functionality and identify locations where the code is to be injected or where other operations are to be carried out. Injected code typically includes added statements, metadata, or other elements at one or more locations, but this term can also include changing, deleting, or otherwise modifying existing source code. Injected code can be stored as one or more templates or in some other form. In addition, it should be appreciated that symbol table manipulations and parse tree transformations can take place.

Based on the symbol table 960 and the parse tree 970, a back-end component 940 can translate the intermediate representation into output code. The back-end component 940 converts the intermediate representation into instructions executable in or by a target processor, into memory allocations for variables, and so forth. The output code can be executable by a real processor, but output code that is executable by a virtual processor can also be provided.

Furthermore, the front-end component 920 and the back end component 940 can perform additional functions, such as code optimization, and can perform the described operations as a single phase or in multiple phases. Various other aspects of the components of compiler 910 are conventional in nature and can be substituted with components performing equivalent functions. Additionally, at various stages during processing of the source code, an error checker component 950 can check for errors such as errors in lexical structure, syntax errors, and even semantic errors. Upon detection error, checker component 950 can halt compilation and generate a message indicative of the error.

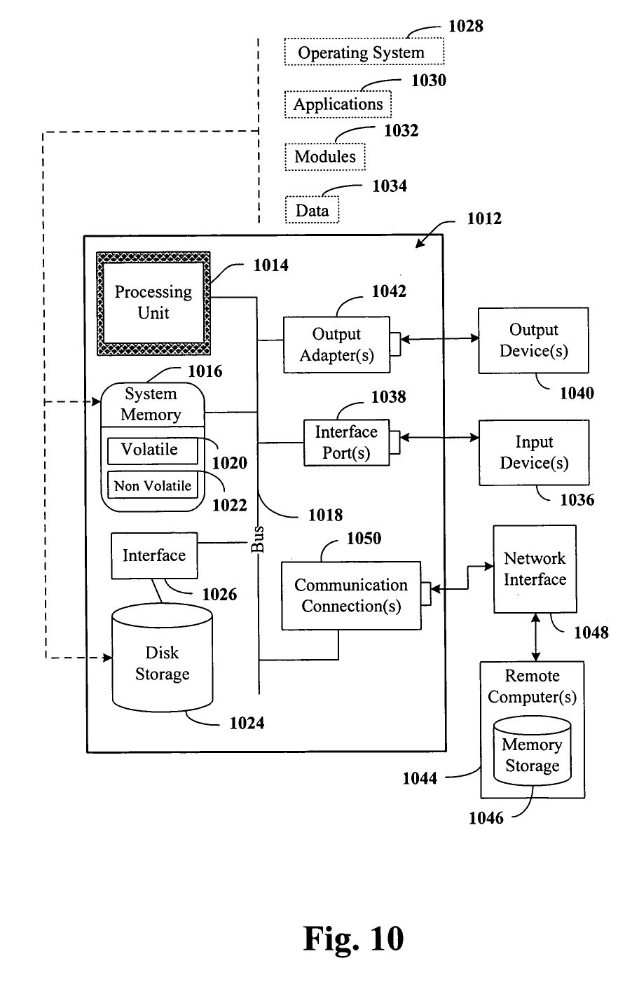

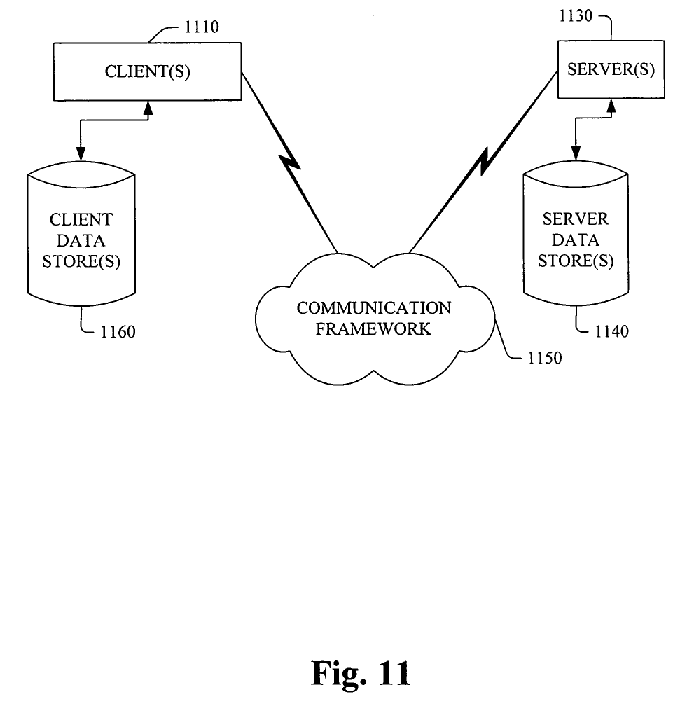

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, etc. that perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 10, an exemplary environment 1010 for implementing various aspects of the subject innovation is described that includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that various components described herein can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 that can be employed to replace constants with expressions in accordance with an aspect of the subject innovation. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the components described herein, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a programming language with expression(s) employable instead of compile time constants, and
a compiler that late binds the programming language.

2. The computer implemented system of claim 1, the expression(s) employed instead of the identifier or keyword associated with a member access expression.

3. The computer implemented system of claim 1, the expression(s) dynamically create a delegate for a later call in event handlers.

4. The computer implemented system of claim 1, the expression(s) employed instead of a parameter name in named arguments.

5. The computer implemented system of claim 1, the expression(s) computes arguments as a list for spliced arguments.

6. The computer implemented system of claim 5, the expression(s) replace type constants and type constructor constants, the expressions compute type and type constructor dynamically.

7. The computer implemented system of claim 1 further comprising a helper associated with the compiler to associated with one of a method name, argument name, a type name as a string and System.Type value and argument splicing, the helper leveraged to place the expression(s) therein.

8. The computer implemented system of claim 7, at least one of a member name, type name being dynamically determinable, and the argument splicing computed as a list.

9. The computer implemented system of claim 1 the programming language is Visual Basic.

10. The computer implemented system of claim 9, IdentifierOrKeyword includes Expression, and the type Expression convertible to string, as MemberAccessExpression
::= [[MemberAccessBase] ] IdentifierOrkeyword
[ (Of TypeArgumentList) ]
IdentifierOrKeyword ::= Identifier | Keyword | (Expression), and
TypeName ::= ArrayTypeName | NonArrayTypeName
NonArrayTypeName ::= SimpleTypeName | ConstructedTypeName
SimpleTypeName ::= QualifiedIdentifier | BuiltInTypeName |

(Expression)
ConstructedTypeName ::= QualifiedIdentifier ( Of TypeArgumentList )

| (Expression) (Of TypeArgumentList)

11. A computer implemented method comprising the following computer executable acts:
replacing compile time constants within at least one of a value expressions, a type expression, and argument list fragment in a programming language; and
late binding the programming language.

12. The computer implemented method of claim 11, the replacing act further comprising employing an expression instead of at least one of: an identifier, a keyword associated with a member access expression, a parameter name associated with a named parameter, fragment of a parameter list associated with a member invocation, an argument splice, and a type name of constructed type name associated with a type expression of the programming language.

13. The computer implemented method of claim 12, further comprising providing at least one of: a method name as a string, a parameter name as a string, parameter as a spliced argument list fragment expression, a simple type name as a string and System.Type expression, and a qualified identifier in a constructed type name as a string or System.Type expression.

14. The computer implemented method of claim 12 further comprising supplying fragments of the programming language as dynamic, and in form of an arbitrary expression.

15. The computer implemented method of claim 12 further comprising replacing identifiers by expressions that compute a member.

16. The computer implemented method of claim 15 further comprising converting type Expression to string as
```
MemberAccessExpression ::= [[MemberAccessBase]]
IdentifierOrKeyword [ (Of TypeArgumentList) ]; and
      extending production for SimpleTypeName and
ConstructedTypeName to include an expression of form (Expression), as
TypeName ::= ArrayTypeName | NonArrayTypeName
NonArrayTypeName ::= SimpleTypeName | ConstructedTypeName
SimpleTypeName ::= QualifiedIdentifier | BuiltInTypeName |
(Expression)
ConstructedTypeName ::= QualifiedIdentifier ( Of TypeArgumentList )
            | (Expression) (Of TypeArgumentList)
```

17. The computer implemented method of claim 11 further comprising computing arguments as a list in spliced arguments.

18. The computer implemented method of claim 17 further comprising replacing constants with dynamic contents.

19. The computer implemented method of claim 17 further comprising employing run time helpers for delay of binding.

20. A computer implemented system comprising the following computer executable components:
syntax means for replacing a compile time constant by an expression computed at run time, and
helper means for delaying of binding.
